(19) United States
(12) Patent Application Publication
(10) Pub. No.: US 2007/0249240 A1
(43) Pub. Date: Oct. 25, 2007

(54) Electrical connector and terminal thereof

(75) Inventor: Chun-Hsiang Chiang, Taipei Hsien (TW)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/788,623

(22) Filed: Apr. 20, 2007

(30) Foreign Application Priority Data
Apr. 21, 2006 (TW) 95206876

(51) Int. Cl. H01R 13/11

(52) U.S. Cl. 439/850

(57) ABSTRACT

An electrical connector comprises an insulating housing and a plurality of terminals. The insulating housing has a plurality of terminal passageways, and each of the terminals has a clipping device, a stopping portion, a first flexible arm, a second flexible arm, and a contacting portion. Each clipping device of the terminals is separately held firmly in the containing trough, and the clipping device further comprises a first clipping portion and a second clipping portion. A containing space is formed between the first clipping portion and the second clipping portion, and a solder ball is clipped relatively in the containing space without reflowing the solder ball to the terminal. A top end of the first flexible arm and a top end of the second flexible arm are connected separately with to the contacting portion so that a top end of the terminal is of closed shape and the terminal will not be hooked by external objects.

### FIELD OF THE INVENTION

The present invention relates to an electrical connector and terminals thereof and more particularly to an electrical connector and terminals thereof with a clipping device for clipping a solder ball.

### BACKGROUND OF THE INVENTION

A chip module of land grid array (LGA) standard as a CPU of the computer is installed on an electrical connector of a circuit board, and the electrical connector comprises a plurality of elastic terminals. When the chip module is pressed to the electrical connector, each of the elastic terminals contacts a corresponding conductive contact of the chip module due to a counteracting force so that the terminals are connected electrically with the conductive contacts of the chip module separately.

A conventional electrical connector, for example disclosed in TW Patent No. 572403, published on Jan. 11, 2004, comprises an insulating housing and a plurality of conductive terminals. The insulating housing has a plurality of terminal passageways receiving the terminals therein. Each of the conductive terminals comprises a base, a holding portion, an arm portion, a curved portion, a contacting portion, and a tail portion. The holding portions of the conductive terminals are fixed in the terminal passageways of the terminals separately, and the curved portions of the conductive terminals are extended to the terminal passageways separately. Solder balls are reflowed to the tail portions of the conductive terminals separately and further reflowed to a circuit board. The contacting portions of the conductive terminals are disposed out of the insulating housing to contact electrically to conductive contacts of a chip module separately.

However, the electrical connector with the single-arm conductive terminals has some following defects:

The solder balls have to be reflowed to the tail portions of the conductive terminals of the electrical connector in advance and then reflowed to the circuit board. Costs of the reflow process is thereby increased and the insulating housing of the electrical connector is distorted due to heat of reflowing.

Small-size of electrical connectors brings the conductive terminals to small scale which deteriorates the elasticity of the curved portions of the conductive terminals. Hence, when the chip module is pressed to the electrical connector, the curved portions of the conductive terminals cannot provide sufficient counteracting force to completely contact the contacting portions of the conductive terminals and thus electrical conducting performance thereof is reduced.

The single-arm terminal provides only a single conductive path so that each of the electrical terminals has large impedance and poor conductivity.

The present invention is presented with reasonable design and good effect to resolve the above problems.

### SUMMARY OF THE INVENTION

It is a primary object of the present invention is to provide an electrical connector and terminals thereof for reducing costs of the reflow process and avoiding thermal distortion of an insulating housing of an electrical connector.

It is another object of the present invention is to provide an electrical connector and terminals thereof for improving elasticity of the terminals of the electrical connector to increase conductivity between the terminals and the conductive contacts of the chip module and to satisfy requirements of the electrical connector.

It is another object of the present invention is to provide an electrical connector and terminals thereof for providing a dual conductive path for reducing impedance of the terminal of the electrical connector so as to improve conductivity of the terminals.

In order to achieve the above and other objectives, the terminals of the electrical connector comprises a clipping device and a stopping portion. The clipping device has a first clipping portion and a second clipping portion, and a containing space is formed between the first clipping portion and the second clipping portion. The stopping portion is connected with the first clipping portion and curved and extended inwardly to the containing space and is vertical to the first clipping portion. Solder balls are clipped reliably in a space surround between a bottom end of the first clipping portion and a bottom end of the second portion and the stopping portion, without reflowing the solder balls to the terminals. Thereby, the costs of the reflow process is reduced and thermal distortion of the insulating housing of the electrical connector can be avoided.

The terminal of the electrical connector comprises a contacting portion, a first flexible arm, and a second flexible arm. A top end of the first flexible arm and a top end of the second flexible arm are connected with two ends of the contacting portion separately. When a chip module is pressed to joint on the terminals, the first flexible arm and the second flexible arm exert a counteracting force on the conductive contacts of the chip module so that the contacting portions contact the conductive contacts more rigidly so as to increase conductivity between the contacting portions and the conductive contacts of the chip module and to satisfy requirements of the electrical connector.

Each of the terminals of the electrical connector comprises a first flexible arm, a second flexible arm, and a clipping device. The clipping device is connected separately to a bottom end of the first flexible arm and a bottom end of the second flexible arm. When a chip module is pressed to joint on the terminal, the first flexible arm and the second flexible arm provide a dual conductive path to reduce impedance of the terminals and improve conducting performance of the terminals.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a perspective view of a terminal of an electrical connector according to one embodiment of the present invention;

FIG. 2 is an exploded perspective view of a circuit board and a chip module of the electrical connector according to one embodiment of the present invention;

FIG. 3 is a partial perspective view of an electrical connector according to one embodiment of the present invention;

FIG. 4 is a plane view of a solder ball installed between a first clipping portion and a second clipping portion of a terminal of an electrical connector according to one embodiment of the present invention; and

FIG. 5 is a plane schematic view of a circuit board and a chip module of an electrical connector (an insulating housing isn't shown) according to one embodiment of the present invention.

The drawings will be described further in connection with the following Detailed Description of the Invention.

### DETAILED DESCRIPTION OF THE PREFERRED EMBODIMENTS

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

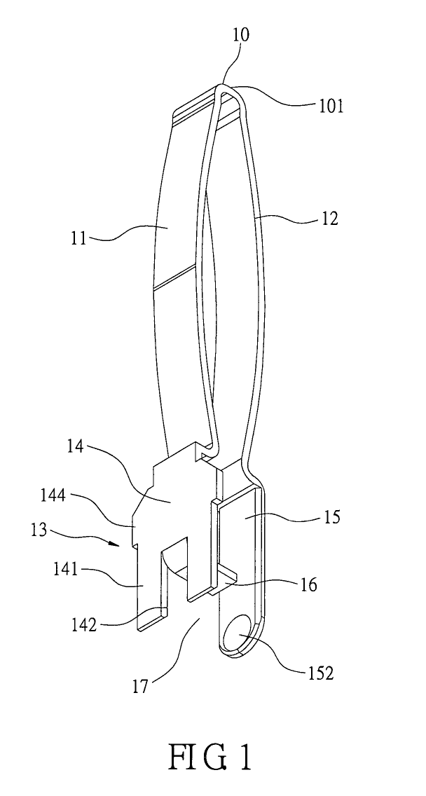

Please refer to FIG. 1 which is a perspective view of a terminal of an electrical connector according to one embodiment of the present invention. A terminal 1 of an electrical connector comprises a contacting portion 10, a first flexible arm 11, a second flexible arm 12, and a clipping device 13. The contacting portion 10 has a top contacting surface 101 on a top end thereof, and the contacting surface is a flat surface or an arc surface with a [symbol] -shaped or reversed U-shaped portion. The contacting portion 10 has two bottom ends separately connected to a top end of the first flexible arm 11 and a top end of the second flexible arm 12. The first flexible arm 11 and the second flexible arm 12 are arranged opposite to each other and extended downwardly from two ends of the contacting portion 10. The first flexible arm 11 and the second flexible arm 12 respectively have an arc portion, and the arc portions curve symmetrically to form respective openings opposite to each other.

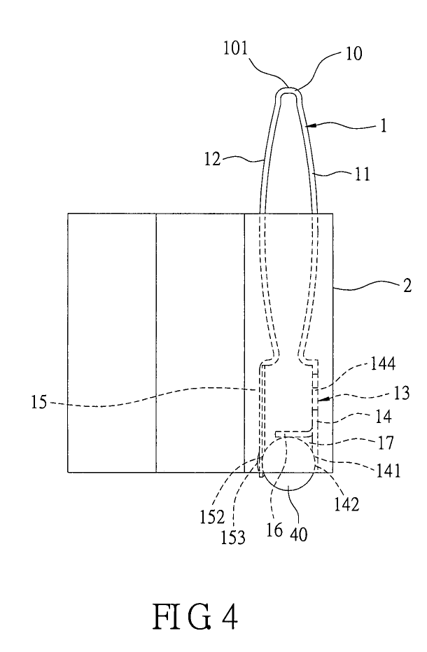

The clipping device 13 comprises a first clipping portion 14, a second clipping portion 15, and a stopping portion 16. The first clipping portion 14 is connected to a bottom end of the first flexible arm 11. The second clipping portion 15 is connected to a bottom end of the second flexible arm 12. The first clipping portion 14 and the second clipping portion 15 are extended downwardly in parallel to form a containing space 17 between the first clipping portion 14 and the second clipping portion 15. A bottom end of the first clipping portion 14 has two clipping claws 141 forming a [symbol] -shape. Each of the two clipping claws 141 has a gap 142 toward the containing space 17 in an inner edge thereof. The stopping portion 16 is connected to a top of the two clipping claws 141 of the first clipping portion 14. Furthermore, each clipping claws 141 is curved and extended inwardly to the containing space 17 and is vertical to the first clipping portion 14 near the second clipping portion 15. In addition, each of the first clipping portions 14 of the terminal 1 has a barb 144 on each of two opposite outer edges thereof. A bottom end of the second clipping portion 15 has a concave 152 facing the containing space 17 so as to form a convex hunch 153 relative to an outward plane of the second clipping portion (as shown in FIG. 4).

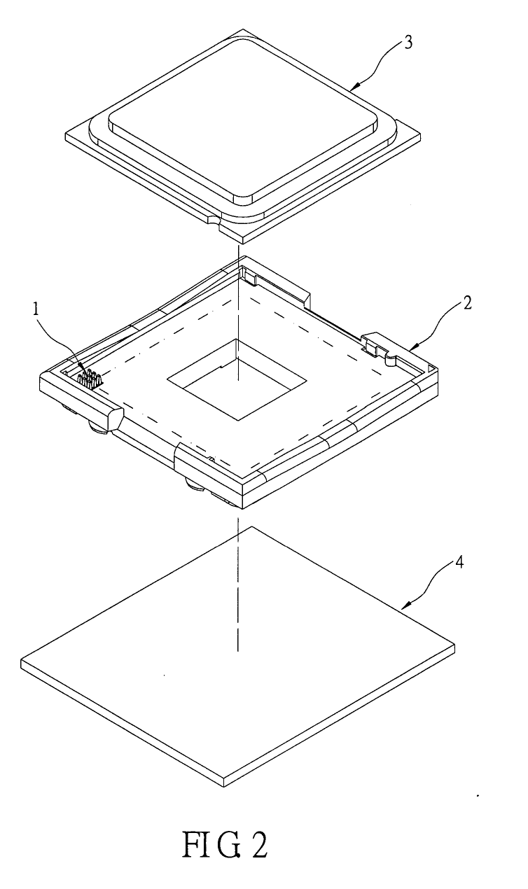

Please refer to FIG. 2 which is an exploded perspective view of a circuit board and a chip module of the electrical connector according to an embodiment of the present invention. The present invention further comprises another electrical connector having an insulating housing 2 and a plurality of terminals 1. The electrical connector is installed on a circuit board 4, and a chip module 3 is installed in the electrical connector.

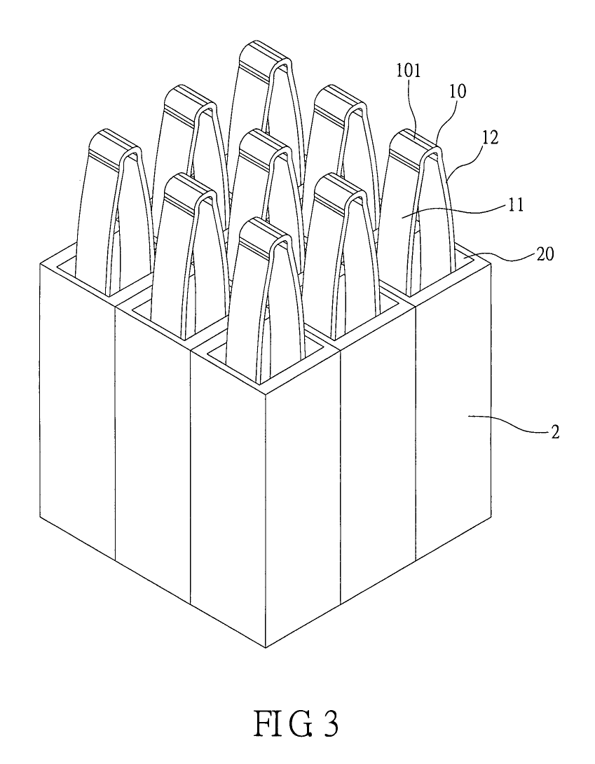

Please refer to FIG. 3 which is a partial perspective view of the electrical connector according to an embodiment of the present invention. The insulating housing 2 is substantially rectangular and has a plurality of terminal passageways 20, and the terminal passageways 20 are substantially rectangular and arranged perpendicularly. The terminals 1 are held firmly in the terminal passageways 20 separately, and the contacting portions 10 of the terminals 1 are extended to the terminal passageways 20 separately. Because the top end of the first flexible arm 11 and the top end of the second flexible arm 12 are connected separately to the contacting portion 10 and extended downwardly into the terminal passageways 20 so that the top end of the terminals 1 will not get hooked by external objects before the chip module 3 is installed to the electrical connector. The position of the terminals 1 is thereby ensured.

Please refer to FIG. 4 which is a plane view of a solder ball installed between a first clipping portion and a second clipping portion of the terminal of the electrical connector according to an embodiment of the present invention. Each of the first flexible arms 11 and the second flexible arms 12 of the terminals 1 is inserted into the corresponding containing trough 20 from a bottom surface of the insulating housing 2. Each clipping device 13 of the terminals 1 is pressed into the containing trough 20 and each barb 144 of the first clipping portion 14 is mated with the insulating housing 2. A solder ball 40 is pressed into a containing space 17 of a corresponding terminal 1. A gap 142 is formed at an inner edge of the clipping claw 141 of the first clipping portion 14 to be mated with a surface of the solder ball 40, and the concave 152 of the bottom end of the second clipping portion 15 is mated with the surface of the solder ball 40 so as to improve reliability of the solder ball 40. As such, the bottom end of the first clipping portion 14 and the bottom end of the second clipping portion 15 clip reliably retain the solder ball 40 in the containing space 17. In addition, the stopping portion 16 stops the solder ball 40 to allow a portion of the solder ball 40 somewhat be exposed accurately to the insulating housing 2 so that all of the solder balls 40 clipped in the containing space 17 can be located accurately on the same plane. The solder balls 40 can be clipped reliably between the bottom end of the first clipping portion 14 and the bottom end of the second clipping portion 15 without reflowing the solder ball to the terminals 1 so as to reduce the costs of having to include a reflow process during the solder ball attachment step and avoid thermal distortion of the insulating housing 2 of the electrical connector that results from this reflow process.

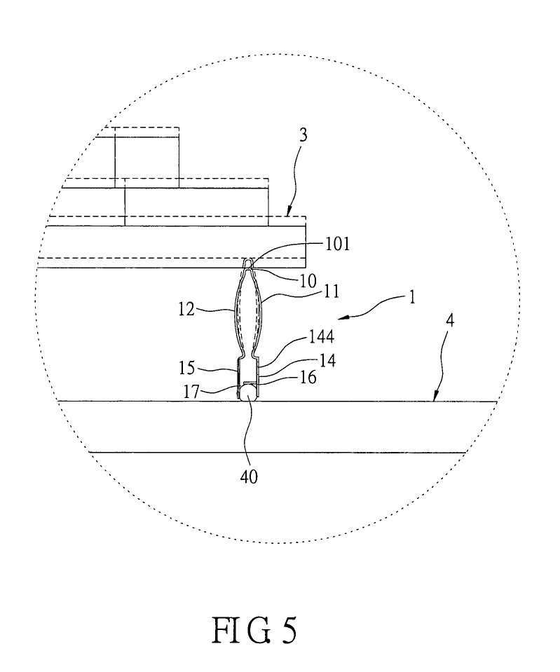

Please refer to FIG. 5 which is a plane schematic view of the circuit board and the chip module of the electrical connector according to one embodiment of the present invention. The electrical connector is installed on the circuit board 4, and the solder balls 40 are connected electrically on conductive contacts (not shown) of the circuit board 4 separately. The chip module 3 such as a CPU (central processing unit) is installed on the electrical connector, and the conductive contacts (not shown) of the chip module 3 are pressed to joint on the contacting surface 101 of the contacting portion 10 so that the clip module 3 can be connected electrically to the circuit board 4 via the electrical connector. The dashed line indicates a schematic view before the chip module 3 mates with the terminals 1, and the solid line indicates a schematic view after the chip module 3 mates with the terminals 1. When the chip module 3 is mated to the terminals 1, the contacting portion 10 is moved downwardly so that the first flexible arm 11 and the second flexible arm 12 are outwardly spread relatively to cause elastic deformation. The first flexible arm 11 and the second flexible arm 12 are disposed on two sides of the contacting portion 10 separately to provide a dual counteracting force so as to improve conductivity between the contacting portion 10 of the terminals 1 and the conductive contacts of the chip module 3 and to satisfy the requirements of the electrical connector. In addition, the first flexible arm 11 and the second flexible arm 12 provide a dual conductive path to reduce impedance of the terminals 1 and improve conductivity thereof.

While a preferred embodiment of the invention is shown and described, it is envisioned that those skilled in the art may devise various modifications without departing from the spirit and scope of the foregoing description and the appended claims.

What is claimed is:

1. A terminal of an electrical connector, comprising:
a clipping device having a first clipping portion and a second clipping portion, and a containing space formed between the first clipping portion and the second clipping portion;
a stopping portion disposed in the containing space and connected with the first clipping portion;
a first flexible arm having a top end and a bottom end, and a bottom end of the first flexible arm connected with a top end of the first clipping portion;
a second flexible arm having a top end and a bottom end, and a bottom end of the second flexible arm connected with a top end of the second clipping portion; and
a contacting portion having two ends connected separately with a top end of the first flexible arm and a top end of the second flexible arm, and the contacting portion having a top contacting surface.

2. The terminal of the electrical connector as claimed in claim 1, wherein each of the first clipping portions of the terminal has a barb on each of opposite outer edges thereof.

3. The terminal of the electrical connector as claimed in claim 1, wherein the first clipping portion further extends downwardly and forms two clipping claws.

4. The terminal of the electrical connector as claimed in claim 3, wherein the stopping portion is connected between the first clipping portion and the two clipping claws.

5. The terminal of the electrical connector as claimed in claim 3, wherein each of the two clipping claws has a gap toward the containing space in an inner edge thereof.

6. The terminal of the electrical connector as claimed in claim 1, wherein the bottom of the second clipping portion has a concave facing the containing space.

7. The terminal of the electrical connector as claimed in claim 1, wherein the contacting surface is a flat surface.

8. The terminal of the electrical connector as claimed in claim 1, wherein the contacting surface is an arc surface.

9. An electrical connector, comprising:
an insulating housing having a plurality of terminal passageways and a plurality of terminals, and each of the terminals comprising:
a clipping device having a first clipping portion and a second clipping portion, and a containing space formed between the first clipping portion and the second clipping portion;
a stopping portion disposed in the containing space and connected with the first clipping portion;
a first flexible arm having a top end and a bottom end, and the bottom end of the first flexible arm connected with a top end of the first clipping portion;
a second flexible arm having a top end and a bottom end, and the bottom end of the second flexible arm connected with a top end of the second clipping portion; and
a contacting portion having two ends connected separately with the top end of the first flexible arm and the top end of the second flexible arm, and the contacting portion having a top contacting surface;
wherein the clipping devices of the terminals are held firmly in the terminal passageways, and the contacting portions of the terminals are extended from the terminal passageways.

10. The terminal of the electrical connector as claimed in claim 9, wherein each of the first clipping portions of the terminal separately has a barb on each of two opposite outer edges thereof.

11. The terminal of the electrical connector as claimed in claim 9, wherein the first clipping portion further extends downwardly and forms two clipping claws.

12. The terminal of the electrical connector as claimed in claim 11, wherein each of the two clipping claws has a gap toward the containing space at an inner edge thereof.

13. The terminal of the electrical connector as claimed in claim 11, wherein the stopping portion is connected between the first clipping portion and the two clipping claws.

14. The terminal of the electrical connector as claimed in claim 9, wherein the bottom end of the second clipping portion has a concave facing to the containing space.

15. The terminal of the electrical connector as claimed in claim 9, wherein the contacting surface is a flat surface.

16. The terminal of the electrical connector as claimed in claim 9, wherein the contacting surface is an arc surface.
